(19) United States
(12) Patent Application Publication
(10) Pub. No.: US 2024/0318995 A1
(43) Pub. Date: Sep. 26, 2024

(54) FLUID LEVEL SENSING APPARATUS, SYSTEMS, AND RELATED METHODS

(71) Applicant: Kai Concepts, LLC, Alameda, CA (US)

(72) Inventors: Donald Lewis Montague, Paia, HI (US); Merten Stroetzel, Pacific Palisades, CA (US); Alec Korver, Monument, CO (US); Leif Jakob Teodor Kuttenkeuler, Saltsjö-Boo-Boo (SE); Mikael Nils Andreas Sundberg, Tyresö (SE)

(21) Appl. No.: 18/603,611

(22) Filed: Mar. 13, 2024

Related U.S. Application Data
(60) Provisional application No. 63/491,201, filed on Mar. 20, 2023.
(60) Provisional application No. 63/491,220, filed on Mar. 20, 2023.
(60) Provisional application No. 63/604,972, filed on Dec. 1, 2023.

(51) Int. Cl. G01F 23/263; B63B 79/10; G01F 25/20

(52) U.S. Cl. CPC G01F 23/266; B63B 79/10; G01F 25/24

(57) ABSTRACT

A fluid level sensing apparatus is disclosed having an electrode assembly, signal generating circuit, and signal processing circuit. The electrode assembly includes a first electrode disposed along an outer surface of the electrode assembly and a second electrode disposed along the outer surface of the electrode assembly, the second electrode separate from the first electrode. The signal generating circuit is configured to output a repeating pulse signal to the first electrode. The signal processing circuit is electrically coupled to the second electrode and configured to receive the signal conducted through the fluid from the first electrode to the second electrode when the electrode assembly is at least partially submersed in the fluid. The signal processing circuit is configured to output a voltage corresponding to a length of the electrode assembly that is submersed in the fluid based at least in part on the signal received by the signal processing circuit.

### CROSS-REFERENCE TO RELATED APPLICATIONS

This application claims the benefit of U.S. Provisional Application No. 63/491,220, filed Mar. 20, 2023, U.S. Provisional Application No. 63/491,201, filed Mar. 20, 2023, and U.S. Provisional Application No. 63/604,972, filed Dec. 1, 2023 which are all hereby incorporated herein by reference in their entireties.

### FIELD

This disclosure relates to sensors for detecting a fluid level and methods of use.

### BACKGROUND

Some watercraft include hydrofoils that extend below a hull, board or platform on which one or more users ride. An example of one such hydrofoiling watercraft is the personal hydrofoiling watercraft disclosed in U.S. Pat. No. 10,940,917, which is incorporated herein by reference in its entirety. As the watercraft is propelled through the water, the water flowing over the hydrofoil provides lift causing a portion of the watercraft to be lifted upward and out of the water. In controlling the operation of watercraft, and particularly hydrofoiling watercraft, it is often useful to know the position and orientation of the watercraft relative to the water. Sensors such as ultrasonic and mmWave radar sensors have been used to monitor the height of a portion of the watercraft relative to the water. For example, an ultrasonic sensor may be mounted to the board of the hydrofoiling watercraft to monitor the height of the board relative to the surface of the water. Existing sensors may have limitations, for example, they are not able to detect small distances and/or are not always reliable due to water spray and/or waves. Further, such sensors are expensive and may be prone to failure in harsh environments. Capacitance sensors capable of electrically detecting contact with a fluid are known. Such sensors, however, may only be capable of detecting presence or absence of the fluid. Further, such sensors may not be reliable when used in fluids having varying conductivity. Thus, there exists a need for an improved device for sensing a fluid level.

### SUMMARY

In some aspects, the techniques described herein relate to a fluid level sensing apparatus including: an electrode assembly submersible into a fluid, including: a first electrode disposed along an outer surface of the electrode assembly; a second electrode disposed along the outer surface of the electrode assembly, the second electrode separate from the first electrode; and a signal generating circuit configured to output a repeating pulse signal to the first electrode; and a signal processing circuit electrically coupled to the second electrode and configured to receive the signal conducted through the fluid from the first electrode to the second electrode when the electrode assembly is at least partially submersed in the fluid, the signal processing circuit configured to output a voltage corresponding to a length of the electrode assembly that is submersed in the fluid based at least in part on the signal received by the signal processing circuit.

In some aspects, the techniques described herein relate to a fluid level sensing apparatus further including a DC barrier including: a first capacitor coupled in series between the first electrode and the signal generating circuit; and a second capacitor coupled in series between the second electrode and the signal processing circuit.

In some aspects, the techniques described herein relate to a fluid level sensing apparatus further including: a first isolating transformer coupled in series between the first electrode and the signal generating circuit; and a second isolating transformer coupled in series between the second electrode and the signal processing circuit.

In some aspects, the techniques described herein relate to a fluid level sensing apparatus wherein the repeating pulse signal is an alternating current signal.

In some aspects, the techniques described herein relate to a fluid level sensing apparatus further including an insulating material separating the first electrode from the second electrode.

In some aspects, the techniques described herein relate to a fluid level sensing apparatus wherein the first electrode extends substantially parallel to the second electrode from an upper end of the electrode assembly to a lower end of the electrode assembly.

In some aspects, the techniques described herein relate to a fluid level sensing apparatus wherein the first electrode is at a lower end of the electrode assembly and the second electrode extends from an upper end of the electrode assembly to a lower end of the electrode assembly.

In some aspects, the techniques described herein relate to a fluid level sensing apparatus wherein the signal processing circuit includes an operational amplifier circuit configured to amplify the signal received from the second electrode.

In some aspects, the techniques described herein relate to a fluid level sensing apparatus wherein the operational amplifier circuit includes a sensitivity adjustment including a variable resistance resistor configured to adjust the output of the fluid level sensing apparatus based on the conductivity of the fluid.

In some aspects, the techniques described herein relate to a fluid level sensing apparatus wherein the signal generating circuit is configured to adjust a power of the repeating pulse signal, the power of the repeating pulse signal output by the signal generating circuit being adjusted based on the conductivity of the fluid.

In some aspects, the techniques described herein relate to a fluid level sensing apparatus wherein the signal processing circuit is configured to output a voltage corresponding to the length of the electrode assembly that is submersed based at least in part on an amplitude of the signal received by the signal processing circuit.

In some aspects, the techniques described herein relate to a fluid level sensing apparatus further including a watertight housing containing the signal generating circuit and the signal processing circuit.

In some aspects, the techniques described herein relate to a fluid level sensing apparatus wherein a frequency of the repeating pulse signal is in a range of 1 kHz to 10 MHz.

In some aspects, the techniques described herein relate to a method of measuring a fluid level along an electrode assembly, the method including: outputting a repeating pulse signal from a signal generating circuit to a first electrode of the electrode assembly; submersing the electrode assembly at least partially into a fluid; receiving a return signal at a signal processing circuit from a second electrode of the electrode assembly, the return signal conducted through the fluid from the first electrode to the second electrode; and outputting a depth signal from the signal processing circuit, the depth signal corresponding to a fraction of a length of the electrode assembly submersed in the fluid.

In some aspects, the techniques described herein relate to a method wherein outputting the signal from the signal generating circuit to the first electrode includes passing the signal through a first DC barrier capacitor, wherein receiving the return signal at the signal processing circuit from the second electrode includes receiving the return signal through a second DC barrier capacitor.

In some aspects, the techniques described herein relate to a method wherein outputting the signal from the signal generating circuit to the first electrode includes passing the signal through a first isolating transformer, wherein receiving the return signal at the signal processing circuit from the second electrode includes receiving the return signal through a second isolating transformer.

In some aspects, the techniques described herein relate to a method wherein outputting the repeating pulse signal to the first electrode includes outputting an alternating current signal to the first electrode.

In some aspects, the techniques described herein relate to a method further including calibrating at least one of the signal generating circuit and signal processing circuit, when the electrode assembly is fully submersed in the fluid, to adjust the output of the signal processing circuit based on the conductivity of the fluid.

In some aspects, the techniques described herein relate to a method wherein calibrating at least one of the signal generating circuit and the signal processing circuit includes adjusting a potentiometer connected in series with a capacitor to an input of an operational amplifier circuit.

In some aspects, the techniques described herein relate to a method wherein calibrating at least one of the signal generating circuit and the signal processing circuit includes adjusting a power of the repeating pulse signal output from the signal generating circuit.

In some aspects, the techniques described herein relate to a method wherein the depth signal corresponds to an amplitude of the signal received at the signal processing circuit.

In some aspects, the techniques described herein relate to a method wherein the repeating pulse signal has a frequency in a range of 1 kHz to 10 MHz.

In some aspects, the techniques described herein relate to a watercraft including: a hull feature at least partially submersible in a body of water; at least one source electrode disposed on the hull feature; at least one receiver electrode disposed on the hull feature and spaced apart from the at least one source electrode; a sensing circuit configured to output a repeating pulse signal to the at least one source electrode and to receive a return signal from the at least one receiver electrode when the at least one source electrode and the at least one receiver electrode are at least partially submersed in the body of water, the sensing circuit configured to output a depth signal corresponding to an extent to which the hull feature is submersed in the body of water based on the return signal.

In some aspects, the techniques described herein relate to a watercraft wherein the sensing circuit further includes a DC barrier including: a source capacitor disposed inline between the sensing circuit and the at least one source electrode; and a receiver capacitor disposed inline between the sensing circuit and the at least one receiver electrode.

In some aspects, the techniques described herein relate to a watercraft wherein the sensing circuit further includes: a first isolating transformer disposed inline between the sensing circuit and the at least one source electrode; and a second isolating transformer disposed inline between the sensing circuit and the at least one receiver electrode.

In some aspects, the techniques described herein relate to a watercraft wherein the repeating pulse signal is an alternating current signal.

In some aspects, the techniques described herein relate to a watercraft wherein a change in resistance between the at least one source electrode and the at least one receiver electrode, indicated based on the return signal, causes the sensing circuit to change the depth signal.

In some aspects, the techniques described herein relate to a watercraft: wherein the at least one source electrode includes a plurality of source electrodes each mounted along the hull feature at different heights; wherein the at least one receiver electrode includes a plurality of receiver electrodes each mounted along the hull feature at different heights; and wherein the sensing circuit is configured to output the repeating pulse signal to the plurality of source electrodes and receive the return signal from receiver electrodes of the plurality of receiver electrodes that are submersed in the body of water.

In some aspects, the techniques described herein relate to a watercraft wherein each source electrode of the plurality of source electrodes is exposed through an opening in the hull feature.

In some aspects, the techniques described herein relate to a watercraft wherein the at least one source electrode and the at least one receiver electrode are embedded in the hull feature.

In some aspects, the techniques described herein relate to a watercraft wherein the hull feature includes a first slot and a second slot extending along at least a portion thereof, the at least one source electrode disposed in the first slot and the at least one receiver electrode disposed in the second slot.

In some aspects, the techniques described herein relate to a watercraft: wherein the hull feature is formed of carbon fiber; wherein the at least one source electrode and the at least one receiver electrode are inlaid in the carbon fiber hull feature.

In some aspects, the techniques described herein relate to a watercraft wherein the at least one source electrode and the at least one receiver electrode are electroplated on the hull feature.

In some aspects, the techniques described herein relate to a watercraft wherein the at least one source electrode and the at least one receiver electrode are secured to an outer surface of the hull feature by one or more of a fastener and/or an adhesive.

In some aspects, the techniques described herein relate to a watercraft wherein the at least one source electrode forms a first portion of the hull feature and the at least one receiver electrode forms a second portion of the hull feature, the hull feature further including an insulator between the first portion and second portion.

In some aspects, the techniques described herein relate to a watercraft wherein the hull feature includes a strut extending to a hydrofoil wing, the at least one source electrode and at least one receiver electrode disposed along the strut.

In some aspects, the techniques described herein relate to a watercraft further including: a board having an upper surface and a lower surface, the hull feature including a strut extending from the lower surface of the board; and a propulsion system mounted to the strut.

In some aspects, the techniques described herein relate to a watercraft wherein the at least one source electrode and the at least one receiver electrode extend along an upper portion of the strut.

In some aspects, the techniques described herein relate to a method of operating a watercraft disposed in a body of water, the method including: outputting a repeating pulse signal from a fluid sensing apparatus to at least one source electrode extending along a hull feature of the watercraft; receiving a return signal at the fluid sensing apparatus from at least one receiver electrode extending along the hull feature of the watercraft and spaced apart from the at least one source electrode, the return signal conducted through the body of water from the at least one source electrode to the at least one receiver electrode; outputting a depth signal from a sensing circuit of the fluid sensing apparatus, the depth signal corresponding to an extent to which the hull feature is submersed in the body of water based at least in part upon the return signal; and automatically adjusting operation of the watercraft based upon the depth signal.

In some aspects, the techniques described herein relate to a method: wherein outputting the repeating pulse signal includes outputting the repeating pulse signal through a source capacitor to at least one source electrode; wherein receiving the return signal includes receiving the return signal through a receiver capacitor from the at least one receiver electrode.

In some aspects, the techniques described herein relate to a method wherein adjusting operation of the watercraft includes adjusting a thrust of a propulsion system of the watercraft.

In some aspects, the techniques described herein relate to a method wherein adjusting operation of the watercraft includes adjusting a position of a movable control surface of the watercraft.

In some aspects, the techniques described herein relate to a method wherein adjusting operation of the watercraft includes adjusting a trim of a propulsion system of the watercraft.

In some aspects, the techniques described herein relate to a method: wherein the at least one receiver electrode includes a plurality of electrodes disposed at varying heights along the hull feature; wherein the at least one source electrode includes a plurality of electrodes disposed at varying heights along the hull feature.

In some aspects, the techniques described herein relate to a method wherein the hull feature includes a strut and a hydrofoil connected to the strut, wherein the at least one source electrode and the at least one receiver electrode are disposed along at least a portion of the strut.

In some aspects, the techniques described herein relate to a method wherein outputting the depth signal is based at least in part on an amplitude of the return signal.

In some aspects, the techniques described herein relate to a method further including comparing the depth signal to a data structure correlating the depth signal to an extent to which the hull feature is submersed in the body of water.

In some aspects, the techniques described herein relate to a method further including calculating an extent to which the hull feature is submersed in the body of water based on the depth signal.

In some aspects, the techniques described herein relate to a method further including: submersing the hull feature to a predetermined depth in the body of water; and calibrating the fluid sensing apparatus when the hull feature is submersed to the predetermined depth in the body of water.

In some aspects, the techniques described herein relate to a method wherein the calibrating further includes adjusting a resistance of a potentiometer such that the depth signal corresponds to an expected depth signal corresponding to the predetermined depth.

In some aspects, the techniques described herein relate to a method wherein calibrating the fluid sensing apparatus includes adjusting a gain of an operational amplifier circuit of the sensing circuit such that the depth signal corresponds to an expected depth signal corresponding to the predetermined depth.

In some aspects, the techniques described herein relate to a method wherein calibrating the fluid sensing apparatus includes adjusting a power of the repeating pulse signal output from the fluid sensing apparatus.

### BRIEF DESCRIPTION OF THE DRAWINGS

FIG. 1 is a block diagram of a fluid level sensing apparatus.

FIG. 2 is a schematic diagram of the fluid level sensing apparatus of FIG. 1 according to one example.

FIG. 3 is a flow chart of a method of sensing the fluid level with the fluid level sensing apparatus of FIG. 1.

FIG. 4 is a perspective view of a personal hydrofoiling watercraft including the fluid level sensing apparatus of FIG. 1.

FIG. 5 is a block diagram of the personal hydrofoiling watercraft of FIG. 4.

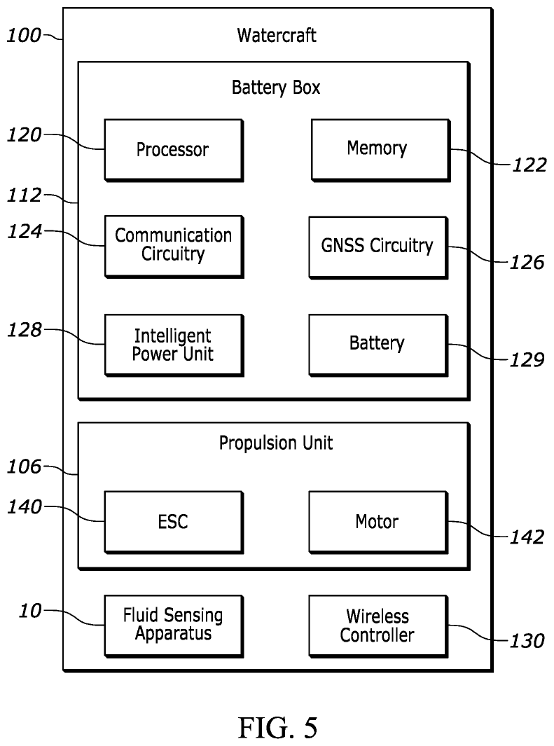

FIG. 6 is a perspective view of the personal hydrofoiling watercraft of FIG. 1 where the fluid level sensing apparatus includes a source electrode comprised of a plurality of electrodes.

FIG. 7 is a perspective view of the personal hydrofoiling watercraft of FIG. 4 where the fluid level sensing apparatus includes source and receiver electrodes each comprised of a plurality of electrodes.

FIG. 8 is a perspective view of the personal hydrofoiling watercraft of FIG. 4 where the source electrode of the fluid level sensing apparatus is a singular electrode terminal.

FIG. 9 is a perspective view of the personal hydrofoiling watercraft of FIG. 4 where the fluid level sensing apparatus includes a plurality of source and receiver electrodes.

FIG. 10 is a cross-sectional view of a strut of the personal hydrofoiling watercraft of FIG. 4 showing the electrodes mounted to an outer surface of the strut.

FIG. 11 is a cross-sectional view of the strut of the personal hydrofoiling watercraft of FIG. 4 showing the electrodes embedded in the strut.

FIG. 12 is a cross-sectional view of the strut of the personal hydrofoiling watercraft of FIG. 4 showing the electrodes received in slots of the strut.

FIG. 13 is a cross-sectional view of the strut of the hydrofoiling watercraft of FIG. 4 where portions of the strut are the electrodes of the fluid level sensing apparatus.

FIG. 14 is a side view of a boat including electrodes of the fluid sensing apparatus of FIG. 1 mounted to a hull of the boat.

### DETAILED DESCRIPTION

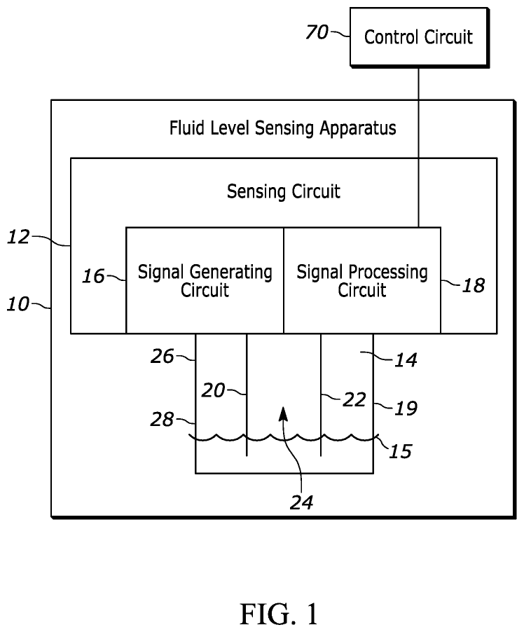

With reference to FIG. 1, a fluid level sensing apparatus 10 is provided. The fluid level sensing apparatus 10 includes a sensing circuit 12 and an electrode assembly 14. The electrode assembly 14 may be at least partially submersed in a fluid (e.g., freshwater, saltwater) and the sensing circuit 12 may be configured to output a fluid level signal indicative of a depth or a length of the electrode assembly 14 that is submersed in the fluid. The sensing circuit 12 comprises a signal generating circuit 16 and a signal processing circuit 18.

The electrode assembly 14 includes a source electrode 20 and a receiver electrode 22. The source electrode 20 and receiver electrode 22 may be formed of any conductive material including metallic wires, foils, or structural components. In certain preferred embodiments the source electrode 20 and receiver electrode 22 are formed of a corrosion resistant metal such as copper, brass, bronze, stainless steel or other suitable conductive materials (e.g., those having a conductivity of more than 4.2×10⁻⁵ S/m). The electrode assembly 14 may further include a support body 19 to which the electrodes 20, 22 are mounted, for example, a support rod or a hull feature of a watercraft such as a hull of a boat or a strut. The source and receiver electrodes 20, 22 may be mounted to an outer surface of the electrode assembly 14, for example, and outer surface of the support body.

The source electrode 20 is electrically coupled to the signal generating circuit 16. For instance, a conductor (e.g., a wire) may extend from the signal generating circuit 16 to the source electrode 20. The receiver electrode 22 is electrically coupled to the signal processing circuit 18. For instance, a conductor (e.g., a wire) may extend from the signal processing circuit to the receiver electrode 22. The receiver electrode 22 may be separated and spaced apart from the source electrode 20 by a gap 24. At least a portion of the electrode assembly 14 between the source electrode 20 and receiver electrode 22 may be formed of an insulating material (e.g., an insulator or dielectric) to inhibit the flow of current through the support body 19 between the electrodes 20, 22 through the electrode assembly 14. In some forms, an insulating pad is positioned between each electrode 20, 22 and the support body to which the electrodes 20, 22 are mounted. In some forms, the electrodes 20, 22 extend substantially parallel to one another along their length, however, in other forms, the electrodes 20, 22 are non-parallel. The electrodes 20, 22 may extend from an upper end 26 of the electrode assembly 14 toward a lower end 28 of the electrode assembly 14.

The sensing circuit 12 detects a fluid level 15 relative to the electrode assembly 14 by transmitting a signal from the source electrode 20 to the receiver electrode 22 through the fluid. The fluid thus serves as a conductive pathway between the electrodes 20, 22. When the electrode assembly 14 is not submersed in the fluid, the receiver electrode 22 will not receive the signal because there is no fluid to conduct the signal between the electrodes 20, 22.

The signal generating circuit 16 of the sensing circuit 12 is configured to output a signal to the source electrode 20. The signal generating circuit 16 may output a repeating pulse signal such as a series of pulses (e.g., a square wave) and/or an alternating signal (e.g., a sine wave oscillating above and below zero). The repeating pulse signal may have a frequency in the range of 1 kHz to 10 MHz. Outputting a repeating pulse signal, rather than a constant DC signal, may limit the flow of ions between the source and receiver electrodes 20, 22 which may reduce corrosion of the electrodes 20, 22 over time. Use of an alternating signal repeatedly reverses the flow of ions between the electrodes 20, 22 which aids to reduce or eliminate corrosion buildup. Reducing or eliminating corrosion on the electrodes 20, 22 aids to maintain the accuracy of the readings of the fluid level sensing apparatus 10 and increases the usable life of the fluid level sensing apparatus 10 before electrodes 20, 22 need to be serviced and/or replaced.

The signal processing circuit 18 is configured to receive the signal from the receiver electrode 22. When the electrode assembly 14 is at least partially submerged in the fluid such that at least a portion of the source and receiver electrodes 20, 22 are submerged, the signal output from the signal generating circuit 16 is conducted by the fluid from the source electrode 20 to the receiver electrode 22 and received by the signal processing circuit 18. Based on the signal received by the signal processing circuit 18 via the receiver electrode 22, the signal processing circuit 18 outputs the fluid level signal indicative of the length of the electrode assembly 14 submersed in the fluid. The length of the electrode assembly 14 submersed in the fluid may correspond to the amplitude of the signal received by the signal processing circuit 18 from the receiver electrode 22. The greater the length of the electrodes 20, 22 that are submersed int the fluid, the lower the resistance of the conductive pathway through the water between the electrodes. In other words, the resistance between the electrodes 20, 22 varies as the portion of the electrodes 20, 22 submersed in water changes which results in a corresponding change in the voltage amplitude of the signal received at the receiver electrode 22. The amplitude change of the signal may linearly correspond to the length of the electrodes 20, 22 submersed in the fluid.

A control circuit 70 may compare the amplitude of the signal received to an amplitude that is known to have been received when the electrode assembly 14 was fully submersed, for example, during calibration of the fluid level sensing apparatus 10. In one example, the control circuit 70 receives the signal generated by the signal processing circuit 18 and compares the value of the signal to an expected value. In the example where the electrode assembly 14 was fully submerged during calibration, the control circuit 70 can adjust the gain of the signal processing circuit 18 such that the signal processing circuit 18 will output a full-scale value when the electrode assembly 14 is fully submerged. Calibration of this sort may be required to account for the composition of the fluid (e.g., saltwater or freshwater) which may result in differing ranges of signal amplitudes received by the signal processing circuit 18 from the receiver electrode 22. The fluid level signal output by the signal processing circuit 18 may, for example, be a voltage that corresponds to the length of the electrode assembly 14 that is submersed. In other examples, the control circuit 70 may be part of the signal processing circuit 18.

As another example, the signal processing circuit 18 may include a processor that determines the length of the electrode assembly 14 submersed in the fluid based on the received signal and output a value indicative of the submersed length. The processor may store the amplitude of the signal received at the second electrode 22 during calibration and may interpolate the length of the electrode assembly 14 submersed in the fluid based on the amplitude received. In other forms, the processor references a dataset associating amplitude values with a submersed length of the electrode assembly 14 to determine the length of the electrode submersed in the fluid.

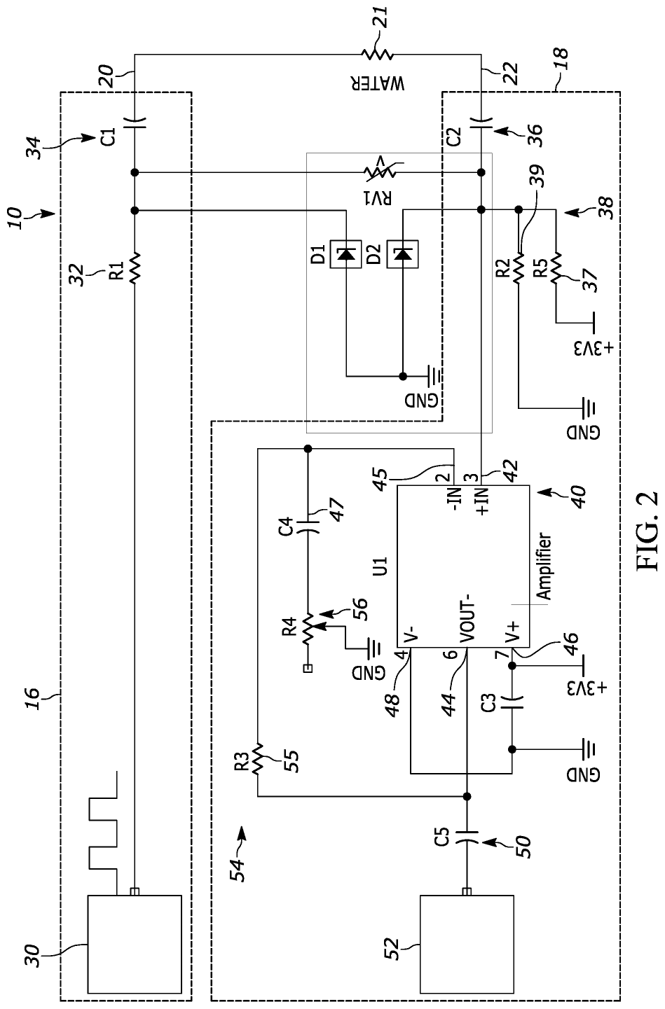

With respect to FIG. 2, a schematic diagram of the fluid level sensing apparatus 10 is provided according to one embodiment. The signal generating circuit 16 includes a signal generator 30 for generating a repeating pulse signal, such as a pulse-width modulated (PWM) square wave signal. In this example, the PWM signal alternates between 0V and 3.3V and has a frequency in the range of 1 kHz to 10 MHz. In other forms, the signal generating circuit 16 may output a wave that does not have a DC bias-meaning that the signal alternates above and below 0V. In other forms, the signal generator 30 may output a sawtooth wave, sine wave or other type of repeating pulse signal.

The signal generator 30 is connected in series with the source electrode 20 through a resistor 32 and a capacitor 34 of the signal generating circuit 16. The signal generated by the signal generator 30 flows through the resistor 32 and the capacitor 34 to the source electrode 20. The capacitor 34 may have a capacitance such that the capacitor 34 functions as a DC blocking capacitor such that it substantially prevents the flow of DC current through the source electrode 20. As mentioned above, limiting or eliminating the DC current through the source electrode 20 aids to reduce or eliminate flow of ions through the water and thus corrosion of the electrodes 20, 22. The capacitor 34 may eliminate the DC bias of the signal output by the signal generator 30 to output an AC signal to the source electrode 20. For example, the capacitor 34 may eliminate the 1.65V DC bias in the square wave such that the square wave oscillates from −1.65V to 1.65V. As one example, where the signal generator outputs a 3.3V square wave signal with a 1 kHz to 10 MHz frequency, the capacitance of the capacitor 34 may be above 10 μF.

In other examples, the capacitor 34 may be replaced with an isolating transformer (e.g., a 1:1 transformer) to eliminate a direct conductive pathway between the signal generator 30 and the source electrode 20. The isolating transformer may be used when the signal generator 30 outputs high voltages.

The signal flows from the source electrode 20 through the fluid 21 to the receiver electrode 22. The resistance of the fluid 21 may vary in part based on the composition of the fluid and thus the fluid level sensing apparatus 10 may need to be calibrated before use as described below. The receiver electrode 22 is connected to the signal processing circuit 18 through a capacitor 36 of the signal processing circuit 18. The capacitor 36 may have a capacitance such that the capacitor 36 functions as a DC blocking capacitor such that it substantially prevents the flow of DC current through the receiver electrode 22. Similar to capacitor 34 of the signal generating circuit 16, limiting or eliminating the DC current through the receiver electrode 22 aids to reduce or eliminate flow of ions through the water and thus corrosion of the electrodes 20, 22. The capacitance of the capacitor 36 may be the same as that of capacitor 34.

In other examples, the capacitor 36 may be replaced with an isolating transformer (e.g., a 1:1 transformer) to eliminate a direct conductive pathway between the receiver electrode 22 and the signal processing circuit 18. The isolating transformer may be used when the signal generator 30 outputs high voltages.

The signal processing circuit 18 includes a DC bias circuit 38 and an operational amplifier circuit 40. The DC bias circuit 38 applies a DC bias to the signal flowing from the receiver electrode 22 to the signal processing circuit 18. In the example illustrated in FIG. 2, the DC bias circuit 38 includes a voltage divider circuit. The DC bias circuit 38 includes a 3.3V source connected through resistor 37 and resistor 39 to ground. The node between resistor 37 and resistor 39 is connected to the capacitor 36 such that a DC bias is applied to the signal flowing from the capacitor 36 to the operational amplifier circuit 40. The voltage applied by the DC bias circuit 38 to the signal from output by the capacitor 36 is set by the resistors 37 and 39 between the 3.3V power source and ground. In one example, the resistance of resistor 37 is the same as resistor 39 such that half of the source voltage (e.g., 1.65V) is applied to the signal. The DC bias circuit 38 may apply a DC bias similar to that of the PWM signal output by the signal generator 30 (e.g., 1.65V) that was eliminated by the DC blocking capacitor 34. Other techniques for providing a DC bias could be used, as would be known to persons skilled in the art.

Input 42 of the operational amplifier 40 receives the signal from the receiver electrode 22 through the DC blocking capacitor 36. The operational amplifier 40 amplifies the signal received from the receiver electrode 22 and outputs the amplified signal through an output 44 of the operational amplifier 40. The operational amplifier 40 has a positive supply voltage input 46 and a negative supply voltage input 48. The voltage available on the positive supply voltage input 46 and negative supply voltage input 48 defines the maximum and minimum voltages the operational amplifier 40 outputs. In one example, the positive supply voltage input 46 is connected to a 3.3V power source and the negative supply voltage input 48 is connected to a 0V power source. In other forms, other voltages may be used. For example, the positive supply voltage input 46 may be connected to a 5V power source and the negative supply voltage input 48 may be connected to a −5V power source.

The operational amplifier 40 includes a feedback loop 54 connected to the negative input 45 of the operational amplifier 40. The relative resistance of resistor 55 and resistor 56 define the gain of the operational amplifier 40, and capacitor 47 is sized to filter the feedback signal by reducing voltage fluctuations.

The signal output from the output 44 operational amplifier 40 is passed through a capacitor 50 which is preferably sized to smooth the signal and filter out any undesired frequencies. The filtered signal may be passed to a voltage monitoring unit 52 of the signal processing circuit 18 that monitors the voltage of the signal output by the operational amplifier 40. The voltage output from the operational amplifier 40 corresponds to a length of the electrode assembly 14 submersed in a fluid. Thus, based on the voltage output of the operational amplifier 40, the level of the fluid relative to the electrode assembly 14 may be determined.

As illustrated, the fluid level sensing apparatus 10 includes a sensitivity adjustment to calibrate the fluid level sensing apparatus 10 based on the type of fluid the fluid level sensing apparatus 10 is monitoring. The variable resistor 56 adjusts the input/output gain of the operational amplifier 40. The variable resistor 56 may be a potentiometer and is preferably a digital potentiometer that can be adjusted electronically by a separate control system (e.g., control circuit 70 illustrated in FIG. 1). The resistance of the variable resistor 56 may be set during a calibration mode of the fluid level sensing apparatus 10. As discussed above, the fluid level sensing apparatus 10 may be used in varying types of fluids including fresh water, saltwater, and mixed water. The conductivity of the fluid is based on the composition of the water, for example, the presence of anions (e.g., chloride, nitrate, sulfate, phosphate) and the presence of cations (e.g., sodium, magnesium, calcium, iron, aluminum). For instance, because saltwater includes more ions, the conductivity of the water is generally higher than freshwater. Where the conductivity of the water is higher, the resistance of the fluid 21 is lower resulting in a smaller voltage drop across the source electrode 20 and receiver electrode 22 compared to lower conductivity water. As a result, the amplitudes of the signal received at the receiver electrode 22 are generally higher when submersed in high conductivity fluid and thus the signal may not need to be amplified or be amplified as much as when submersed in lower conductivity fluid.

To calibrate the fluid level sensing apparatus 10, the signal processing circuit 18 sets the resistance of the variable resistor 56 when the electrode assembly 14 is submerged to a known depth. For example, the value of the variable resistor 56 is preferably calibrated when the electrode assembly 14 is fully submerged in the fluid. The amplitude of the signal received at the receiver electrode 22 will be at its maximum when the electrode assembly 14 is fully submerged. The input/output gain of the operational amplifier 40 may be set when the electrode assembly 14 is fully submerged to prevent the signal from being clipped. For example, the gain may be set so that the output voltage of the operational amplifier 40 does not exceed the voltage of the voltage supply input 46 when the electrode assembly 14 is fully submerged (and when the signal at the receiver electrode 22 has the greatest amplitude).

In some forms, fluid level sensing apparatus 10 may calibrate the signal generator 30 based on the conductivity of the fluid in which the electrode assembly 14 is submersed. More specifically, the fluid level sensing apparatus 10 may adjust the amplitude of the signal generated by the signal generator 30. For example, when the electrode assembly 14 is fully submersed, the fluid level sensing apparatus 10 may adjust (e.g., increase or decrease) the amplitude of the signal output to the source electrode 20 such that the amplitude of the signal received at the receiver electrode 22 is a desired amplitude. For instance, the signal generator 30 may output a high-voltage signal when the fluid level sensing apparatus 10 is with freshwater and output a low-voltage signal when the fluid sensing apparatus is used with saltwater. The fluid level sensing apparatus 10 may calibrate the signal generator 30 in addition to or as an alternative to calibrating the gain of operational amplifier 40.

In some forms, the signal processing circuit 18 of the fluid level sensing apparatus 10 does not include the operational amplifier 40. The signal received through the capacitor 36 from the receiver electrode 22 may be passed to the voltage monitoring unit 52 to read the amplitude of the signal to determine the level of the fluid relative to the electrode assembly 14. Such a signal processing circuit 18 may be appropriate in systems designed to operate in a fluid with known composition and/or when the signal generator 30 is calibrated to compensate for differences in the composition of the fluid.

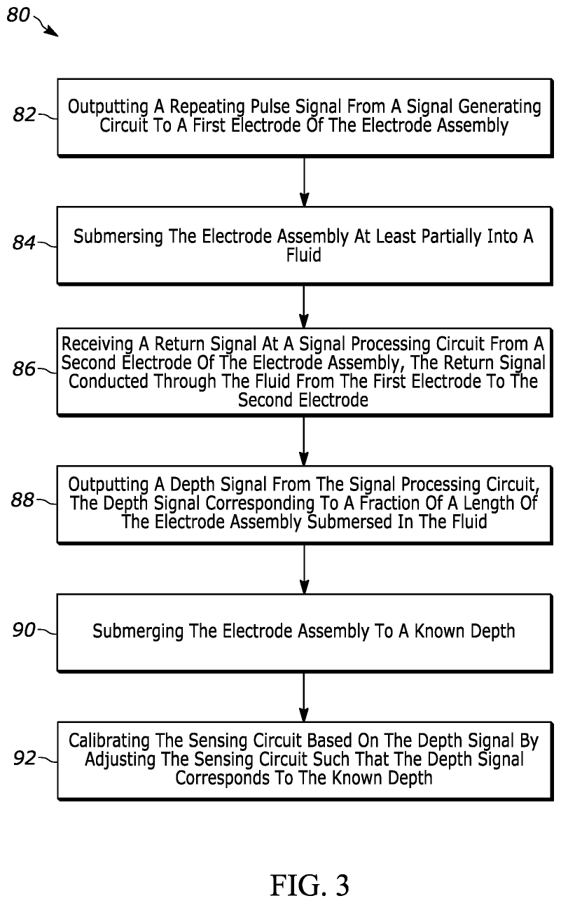

With reference to FIG. 3 a method 80 of sensing the fluid level with the fluid level sensing apparatus 10 is provided. At step 82, the signal generating circuit 16 outputs a repeating pulse signal to the first electrode 20 of the electrode assembly 14. As discussed above, the repeating pulse signal may be an alternating signal or a series of pulses. The repeating pulse signal may be passed through a first DC barrier capacitor 34 to inhibit DC current from flowing through the first electrode 20. In some forms, the repeating pulse signal is passed through an isolating transformer. At step 84, the electrode assembly 14 of the fluid level sensing apparatus 10 is at least partially submersed into the fluid such that a portion of the first electrode 20 and second electrode 22 are submersed in the fluid. The electrode assembly 14 may be submersed by a user manually submersing the electrode assembly 14. In another form, the electrode assembly 14 is disposed in a tank or basin where the electrode assembly is partially submersed in a fluid. In another form, the electrode assembly 14 is mounted to a watercraft where the electrode assembly is at least partially submersed in a resting state.

At step 86, the fluid level sensing apparatus 10 receives a return signal at the signal processing circuit 18 from the second electrode 20. The fluid in which the electrode assembly 14 is at least partially submersed conducts the signal output from the first electrode 20 to the second electrode 22. The repeating pulse signal may be received through a second DC barrier capacitor 36 to inhibit DC current from flowing through the second electrode 22. In some forms, the repeating pulse signal is received through an isolating transformer. At step 88, the fluid level sensing apparatus 10 outputs a depth signal from the signal processing circuit 18 where the depth signal corresponds to a fraction of a length of the electrode assembly 14 that is submersed in the fluid. The depth signal may correspond to an amplitude of the signal received at the signal processing circuit 18 from the second electrode 22. For example, the greater the fraction of the electrode assembly 14 submersed in fluid, the greater the amplitude of the return signal and thus the greater the value of the depth signal (which could be a voltage, current, or amplitude of a voltage or current on a repeating signal). The signal processing circuit 18 may output the depth signal to a processor to store in memory and/or to automatically take action based on the depth signal.

The method 80 may further include calibrating the signal generating circuit 16 and/or signal processing circuit 18 to adjust the output of the signal processing circuit 18 based on the conductivity of the fluid. Step 90 requires submerging the electrode assembly 14 to a known depth. For example, the signal generating circuit 16 and/or signal processing circuit 18 may be calibrated when the electrode assembly 14 is fully submersed in the fluid. At step 92, calibration is performed by adjusting the sensing circuit 12 such that the depth signal corresponds to the known depth of the electrode assembly 14. As discussed above, the signal processing circuit 18 may be calibrated by adjusting a potentiometer or variable resistor 56 that adjusts the gain of an operational amplifier circuit 40. The signal generating circuit 16 may also or alternatively be calibrated by adjusting a power (e.g., voltage amplitude) of the repeating pulse signal output from the signal generating circuit 16.

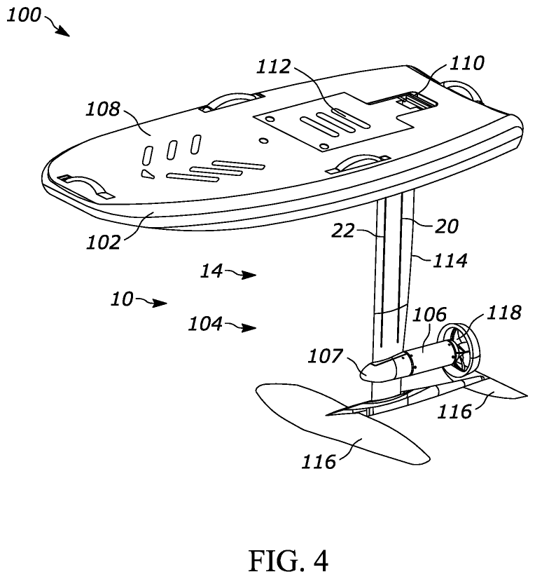

FIGS. 4 and 6-9 illustrate various examples in which the fluid sensing apparatus 10 is implemented in the context of a watercraft 100—specifically illustrated as an electrically propelled hydrofoiling watercraft. The illustrated hydrofoiling watercraft 100 has a board 102, a hydrofoil 104, and an electric propulsion unit 106 mounted to the hydrofoil 104. The board 102 may be a rigid board formed of fiberglass, carbon fiber or a combination thereof, or an inflatable board. The top surface of the board 102 forms a deck 108 on which a user or rider may lay, sit, kneel, and/or stand to operate the watercraft 100.

The hydrofoiling watercraft 100 may include a battery box 112 that is mounted into a cavity 110 on the top side of the board 102. The battery box 112 may house a battery 129 for powering the watercraft 100, an intelligent power unit (IPU) 128 that controls the power provided to the electric propulsion unit 106, communication circuitry 124, Global Navigation Satellite System (GNSS) circuitry 126, and/or a computer (e.g., processor 120 and memory 122) for controlling the watercraft or processing data collected by one or more sensors of the watercraft 100, such as a fluid level sensing apparatus 10 discussed in further detail below. The watercraft 100 may determine the location of the watercraft at any given time using the GNSS circuitry 126. The communication circuitry 124 may be configured to communicate with a wireless remote controller enabling a rider to control the hydrofoiling watercraft 100. The communication circuitry 124 may also be configured to communicate data and information with a remote computer, such as a server computer, via a network (e.g., cellular and/or the internet).

The hydrofoil 104 includes a strut 114 and one or more hydrofoil wings 116. The propulsion unit 106 may be mounted to the strut 114 with a bracket 107 that permits the propulsion unit 106 to be mounted to or clamped onto the strut 114 at varying heights or positions along the strut 114. The strut 114 may be formed of fiberglass, plastic, aluminum, and/or a carbon fiber. Power wires and/or a communication cable may extend through the strut 114 from the battery box 112 to the propulsion unit 106 to provide power and operating instructions to the propulsion unit 106. The propulsion unit 106 may contain an electronic speed controller (ESC) 140 and a motor 142. In some embodiments, the propulsion unit 106 also includes the battery and/or the IPU. The motor includes a shaft that is coupled to a propeller 118. The ESC 140 provides power to the motor based on the control signals received from the IPU 128 of the battery box 112 to operate the motor and cause the shaft of the motor to rotate. Rotation of the shaft turns the propeller which drives the watercraft through the water. In other forms, a waterjet may be used in place of the propeller 118 to drive the watercraft through the water.

As the hydrofoiling watercraft 100 is driven through the water by way of the motor, the water flowing over the hydrofoil wings 116 provides lift. This causes the board 102 to rise above the surface of the water when the watercraft 100 is operated at or above certain speeds such that sufficient lift is created. While the hydrofoil wings 116 are shown mounted to the base of the strut 114, in other forms, the hydrofoil wings 116 may extend from the propulsion unit 106. The propulsion unit 106 thus may be a fuselage from which hydrofoil wings 116 extend. In some forms, the hydrofoil wings 116 are mounted above the propulsion unit 106 and closer to the board 102 than the propulsion unit 106. In some forms, the hydrofoil wings 116 and/or the propulsion unit 106 include movable control surfaces that may be adjusted to provide increased or decreased lift and/or to steer the watercraft 100. For instance, the movable control surfaces may be pivoted to adjust the flow of fluid over the hydrofoil wing or the propulsion unit 106 to adjust the lift provided by the hydrofoil wing, increase the drag, and/or turn the watercraft 100.

The fluid level sensing apparatus 10 may be used to monitor the position of the board 102 relative to the surface of the water, for example, according to method 80 of FIG. 3. The source electrode 20 and receiver electrode 22 may be mounted to the strut 114. The strut 114 may form a body of the electrode assembly 14 and may include the insulating material between the electrodes 20, 22. As shown in FIG. 4, the source electrode 20 and receiver electrode 22 may extend along a length of the outer surface of the strut 114, although the electrodes 20, 22 may be mounted to the strut 114 in other configurations such as those discussed below. The signal generating circuit 16 and/or signal processing circuit 18 may be housed in the battery box 112 (e.g., a watertight container) and may be part of the computer system of the hydrofoiling watercraft 100. Conductors, such as wires, may extend from the electrodes 20, 22 to the signal generating circuit 16 and signal processing circuit 18. For example, the conductors may extend to the battery box 112 along with the power and communication wires extending to the propulsion unit 106. For instance, the conductors may be electrically connected to the battery box 112 via the connector disclosed in U.S. Pat. No. 10,946,939 which is incorporated by reference herein in its entirety.

The fluid level sensing apparatus 10 may be calibrated when the board 102 is unpowered and substantially stationary in the water, for example, when the hydrofoiling watercraft 100 is not operating. A user may place the hydrofoiling watercraft 100 in the water in such a resting position, for example, where the electrodes 20, 22 are fully submerged. When resting, the processor 120 may automatically calibrate the fluid level sensing apparatus 10 based on the conductivity of the water as described above. For example, the fluid level sensing apparatus 10 may calibrate upon a user pairing the remote controller with the hydrofoiling watercraft 100 or otherwise indicating that the user would like to begin operating the hydrofoiling watercraft 100. The hydrofoiling watercraft 100 may include other sensors for monitoring the ride height of the board 102, for example, ultrasonic and/or mm Wave radar. The hydrofoiling watercraft 100 may calibrate the fluid level sensing apparatus 10 upon detecting that the board 102 is resting in the water. The fluid level sensing apparatus 10 may recalibrate frequently, for example, every time the hydrofoiling watercraft 100 is not operating and the board 102 is substantially stationary in the water. Calibrating frequently may ensure that the fluid level sensing apparatus 10 accurately determines the ride height of the board 102, for example, even if the conductivity of the fluid changes (e.g., when the hydrofoiling watercraft 100 is used in mixed water).

A user may desire to know the height at which the board 102 is positioned above the water during operation of the hydrofoiling watercraft 100. The ride height of the board 102 may be displayed to the user in real time, for example, on a display screen of the remote controller. In some forms, the hydrofoiling watercraft 100 may automatically control the ride height of the board 102, for example, where the hydrofoiling watercraft 100 operates autonomously or provides ride assistance to the user as discussed, for example, in U.S. Application Nos. 63/491,220 and 63/604,972. The hydrofoiling watercraft 100 may receive the fluid level data from the fluid level sensing apparatus 10 and adjust operation of the hydrofoiling watercraft 100 to maintain and/or achieve a desired ride height. For example, if the ride height of the board 102 is changing (e.g., increasing or decreasing) from a desired ride height, the hydrofoiling watercraft 100 may adjust the thrust of the propulsion unit 106. For instance, the watercraft 100 may increase or decrease the speed of the motor of the propulsion unit 106. As another example, the watercraft 100 may change a direction of the thrust of the propulsion unit by moving the propulsion unit 106 to point in a desired direction. As another example, the watercraft 100 may adjust a movable control surface of the hydrofoiling watercraft 100 to achieve the desired ride height. The computer of the hydrofoiling watercraft 100 may monitor the fluid level data over a period of time to detect the wave height and may determine a ride height of the board based on an average fluid level relative to the strut 114 over a period of time. The hydrofoiling watercraft 100 may operate autonomously using the GNSS circuitry 126 to control the route of the hydrofoiling watercraft 100 and/or using the fluid level sensing apparatus 10 to maintain the ride height of the board 102.

The fluid level sensing apparatus 10 provides an improved ride height sensing device compared to existing systems. The fluid level sensing apparatus 10 is able to provide a reading of the fluid level relative to the strut 114 in real time permitting the computer of the hydrofoiling watercraft 100 to make control decisions in real time. Unlike many existing systems, such as radar and or ultrasonic systems, that are often not accurate for measuring short distances (e.g., distances of less than one foot), the fluid level sensing apparatus 10 is able to provide accurate ride height readings at all ride heights. The fluid level sensing apparatus 10 is able to provide accurate readings despite water spray and/or waves unlike these existing systems. The hydrofoiling watercraft 100 may receive data from a suite of sensors monitoring the height of the board 102 including the fluid level sensing apparatus 10 and may determine the ride height of the board based on the received data from each of the sensors.

In some applications, a set of electrodes may be mounted on each side of a watercraft, for example, to monitor the roll of the watercraft. For example, where a hydrofoiling watercraft includes two or more struts 114, a set of electrodes may be mounted on a left side strut 114 and a set of electrodes may be mounted on the right side strut 114. The water level on each side of the watercraft may be monitored to determine a difference in the fluid level on each side of the watercraft which may be indicative of a roll the watercraft. A computer of the watercraft may adjust operation of the watercraft based on the detected roll of the watercraft. For example, a computer of the hydrofoiling watercraft 100 may adjust the position of a movable control surface (e.g., on a hydrofoil wing) to counter the roll and/or stabilize the watercraft.

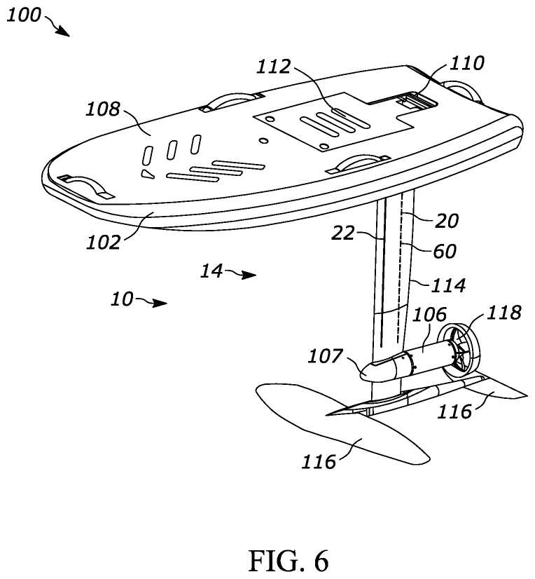

With respect to FIG. 6, the electrodes 20, 22 of the fluid level sensing apparatus 10 are provided according to another embodiment. The source electrode 20 includes a plurality of electrode terminals 60 that are exposed through the strut 114 along the length of the strut 114. The source electrode 20 may include any number of electrode terminals 60. The spacing between each electrode terminal 60 may also vary. Each of the series of electrode terminals 60 may be connected to a common conductor or bus extending through the strut 114 along its length. The electrode terminals 60 may be conductive rods extending outward from the common conductor through the strut 114 to be exposed to the water. The signal output by the signal generating circuit 16 may thus be output to each of the electrode terminals 60 at the same time. In other forms, each of the series of electrodes terminals 60 may be separately connected to the signal generating circuit 16. The signal generating circuit 16 may output the signal to each of the electrode terminals 60 individually (e.g., sequentially from bottom to top) to detect the fluid level relative to the electrode assembly 14. For example, if the signal is output from a specific electrode terminal 60 and the signal not detected at the receiver electrode 20, the fluid level sensing apparatus 10 may determine that that that specific electrode terminal 60 is not in the fluid.

In other embodiments, the source electrode 20 is a continuous conductor that extends along the length of the strut 114 and the receiver electrode 22 is comprised of a plurality of electrode terminals extending along the strut 114 similar to the source electrode of FIG. 6. In forms of this embodiment, the electrode terminals may be connected to a common conductor extending along the strut 114 that is electrically connected to the signal processing circuit 18. In other forms, each electrode terminal is separately connected to the signal processing circuit 18 such that the signal processing circuit 18 is able to determine which electrode terminal received the signal. The signal generating circuit 16 may output a signal to the source electrode 20 which may be received by some or all of the electrodes of the receiver electrode 20. The signal processing circuit 18 may determine which of the plurality of electrode terminals of the receiver electrode 20 received the signal to determine the fluid level.

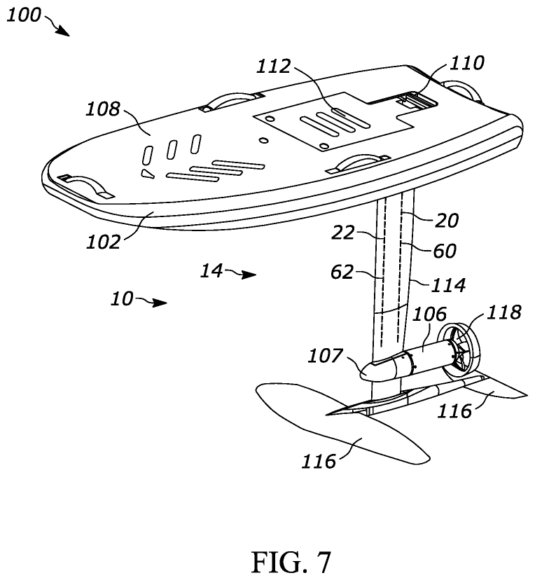

With respect to FIG. 7, both the source electrode 20 and the receiver electrode 22 are comprised of a plurality of electrode terminals, including electrode terminals 60 comprising the source electrode 20 and electrode terminals 62 associated with the receiver electrode 22. The electrode terminals 60, 62 may extend along the length of the strut 114. The electrode terminals 60 of the source electrode 20 may be electrically connected together or individually to the signal generating circuit 16 as described above. The electrode terminals 62 of the receiver electrode 22 may similarly be electrically connected together or individually to the signal processing circuit 18 as described above.

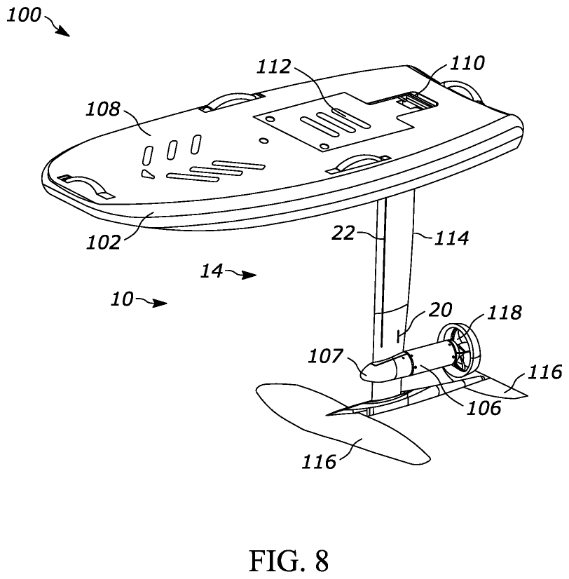

With respect to FIG. 8, the receiver electrode 22 extends along the length of the strut 114 but the source electrode 20 does not extend along the entire length of the strut 114. The source electrode 20 may be a point electrode or have a length that is substantially shorter than the receiver electrode 22. The source electrode 20 may be positioned at the lower end of the strut 114, for example, at a portion of the strut 114 that should be submersed in fluid during normal operation of the hydrofoiling watercraft 100. The signal processing circuit 18 may receive the signal through the receiver electrode 22. The length of the strut 114 submersed in the fluid may be determined based on the amplitude of the signal received at the receiver electrode 22, which increases as the length of the receiver electrode 22 submersed in the fluid increases. In other forms, the receiver electrode 22 may be comprised of the electrode terminals 62 described above. As the conductive surface area of the receiver electrode 22 that is in the water increases, the amplitude of the signal received at the signal processing circuit 18 increase and vice versa.

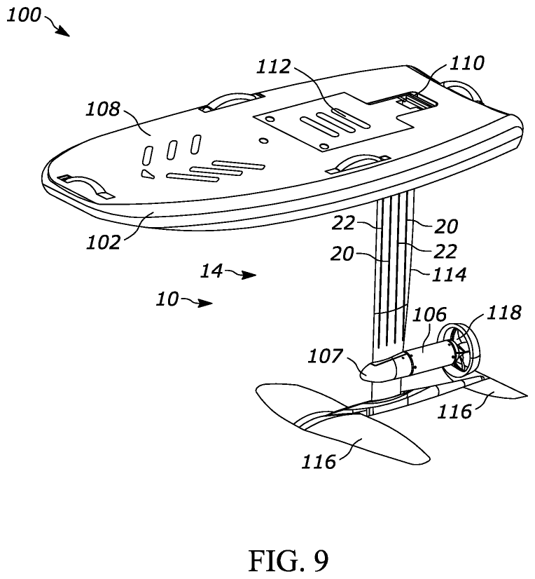

With respect to FIG. 9, the fluid sensing apparatus 10 may have multiple source electrodes 20 and/or multiple receiver electrodes 22. In the form shown, the fluid sensing apparatus 10 includes two source electrodes 20 and two receiver electrodes 22. In other forms, however, any number of source and receiver electrodes 20, 22 may be used. Use of multiple source and/or receiver electrodes 20, 22 may increase the amplitude of the signal received at the signal processing circuit 18. Use of multiple source and/or receiver electrodes 20, 22 may also provide redundancy such that the fluid level is able to be sensed even if an electrode 20, 22 is damaged or needs servicing.

In some forms, a set of source and receiver electrodes 20, 22 may be positioned on each side of the watercraft (e.g., each side of the strut 114 for the hydrofoiling watercraft 100 example) which may be used to detect the orientation or roll of the watercraft based on the difference in the length of the strut submersed in water that is detected on each side of the watercraft. In some forms, the fluid sensing apparatus 10 includes one or more source electrode 20 and a plurality of receiver electrodes 22. Including a plurality of receiver electrodes 22 may increase the amplitude of the signal received at the signal processing circuit 18. In some forms, the signal processing circuit 18 receives the signal from each receiver electrode 22 of the plurality individually and thus is able to sense the length of each receiver electrode 22 submersed in the water which may be useful for determining the orientation (e.g., roll and/or pitch) of the watercraft 100.

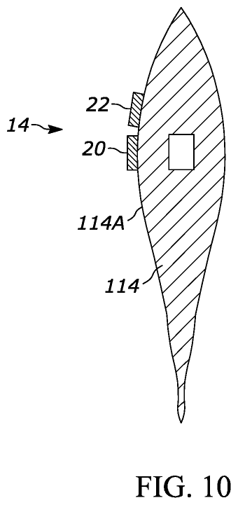

With respect to FIG. 10, a cross-sectional view of the strut 114 of the hydrofoiling watercraft 100 is shown with the source electrode 20 and receiver electrode 22 mounted to the strut 114. As shown, the source electrode 20 and receiver electrode 22 may be secured to an outer surface 114A of the strut 114. For example, the electrodes 20, 22 may be secured to the outer surface of the strut with one or more fasteners (e.g., a screw, rivet) and/or an adhesive (e.g., a waterproof glue). In some forms, the electrodes 20, 22 are electroplated onto the strut 114.

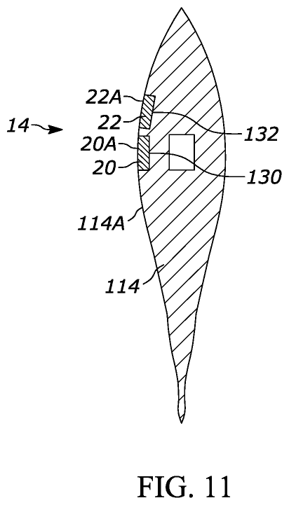

With respect to FIG. 11, a cross-sectional view of the strut 114 is shown with the source and receiver electrodes 20, 22 embedded into the strut 114. The strut 114 may be formed with one or more recesses 130, 132 along the strut into which the electrodes 20, 22 may be placed. The electrodes may be secured to the strut within the recesses 130, 132 with one or more fasteners (e.g., a screw, rivet) and/or an adhesive (e.g., a waterproof glue). In some forms, the electrodes 20, 22 are electroplated onto the strut 114 in the recesses 130, 132. Embedding the electrodes 20, 22 within the strut 114 may reduce or eliminate the distance the electrodes 20, 22 extend from the outer surface 114A of the strut 114, which may reduce drag caused by the electrodes 20, 22 and be more hydrodynamic. For instance, the outer surfaces 20A, 22A of the electrodes 20, 22 may be flush with the outer surface 114A of the strut 114.

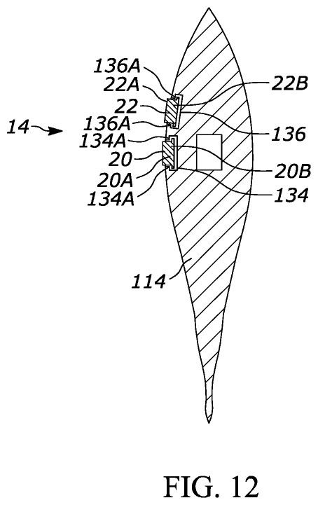

With respect to FIG. 12, a cross-sectional view of the strut 114 is shown with slots 134, 136 receiving the source and receiver electrodes 20, 22. The slots 134, 136 may extend along the length of the strut 114 and define an opening through which the electrodes 20, 22 are exposed to the water. The source and receiver electrodes 20, 22 may have a substantially T-shaped cross-section with an inner portion 20B, 22B that is wider than the outer portion of the electrodes. The slots 134, 136 may have a lips 134A, 136A that hook the wider portion of the electrodes 20,22 and inhibit the electrodes from passing through the opening of the slots 134, 136. The electrodes 20, 22 may be slid into the slots 134, 136 (e.g., from the top of the strut 114) to attach the electrodes 20, 22 to the strut 114. The electrodes 20, 22 may further be secured to the strut 114 by fasteners and/or an adhesive as described above. The outer surface 20A, 22A of the electrodes 20, 22 may be flush with the outer surface 114A of the strut 114 to make the strut assembly more hydrodynamic as discussed above.

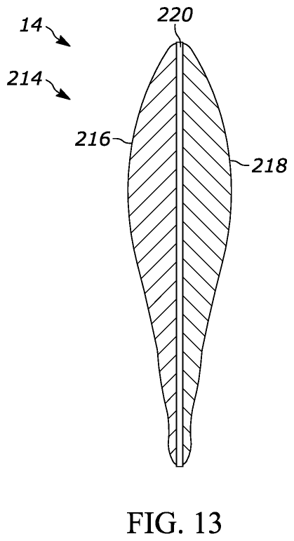

With respect to FIG. 13, a cross-sectional view of the strut 114 of the hydrofoiling watercraft 100 is shown where portions of the strut 214 form the electrodes 20, 22 of the electrode assembly 14. The strut 214 includes a first conductive portion 216, a second conductive portion 218, and an insulating portion 220 between the first and second conductive portions 216, 218. The conductive portions 216, 218 may be formed of a conductive material such as, for example, aluminum, carbon fiber, and/or a metal alloy. The first conductive portion 216 may be the source electrode 20 to which the signal generating circuit 16 transmits the repeating pulse signal. The signal generating circuit 16 may be electrically connected to the first conductive portion 216. The second conductive portion 218 may be the receiver electrode 22 that receives the repeating pulse signal through the body of water in which the strut 214 is submersed. The signal processing circuit 18 may be electrically connected to the second conductive portion 218 to receive the return signal. The insulating portion 220 is positioned between the first and second conductive portions 216, 218 to prevent current from flowing directing from the first conductive portion 216 to the second conductive portion 218 and vice versa. The insulating portion 220 ensures that the current flowing between the first and second conductive portions flows through the body of water in which the strut 214 is submersed. The insulating portion 220 may be formed of a fiber glass and/or a plastic as examples.

The examples shown in FIGS. 10-13 can be applied equally in each of the embodiments illustrated in FIGS. 4 and 6-9. The means by which the electrode is affixed to, embedded in, or assembled with the strut apply equally regardless of whether the electrode is exposed to the outside continuously (e.g., the electrodes 20, 22 in FIG. 4) or as a series of electrode terminals (e.g., the terminals 60 and 62 in FIGS. 6 and 7).

While the fluid level sensing apparatus 10 has been described in use with the hydrofoiling watercraft 100, the fluid level sensing apparatus 10 may be used with other types of watercraft to similarly monitor the position and/or orientation of the watercraft relative to the surface of the water. The position and/or orientation of the watercraft may be used in operating the watercraft, for example, to automatically adjust operation of the watercraft.

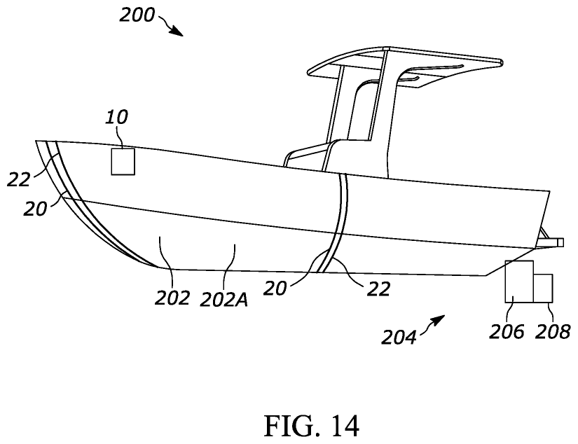

With respect to FIG. 14, a boat 200 including the fluid level sensing apparatus 10 is provided. The boat 200 includes a hull 202 and a propulsion system 204 attached to the hull 202. The propulsion system 204 includes a motor 206 that turns a propeller 208 to drive the boat 200 through the water. The source and receiver electrodes 20, 22 of the fluid level sensing apparatus 10 may extend along an outer surface 202A of the hull 202 to monitor the surface of the fluid relative to the hull 202. The fluid level sensing apparatus 10 may be used to monitor the wetted surface of the hull 202 which may be used to determine the pitch and/or roll of the boat 200.

As shown, a set of electrodes 20, 22 may extend along the front of the hull 202 from the top toward a bottom of the hull 202. As the boat 200 accelerates through the water, the bow of the boat 200 may be lifted from the water. The fluid level sensing apparatus 10 may be used to monitor the portion of the hull 202 that is submersed in water. A computer of the boat 200 may receive the data from the fluid level sensing apparatus 10 indicating the portion of the hull 202 submersed in water and may automatically adjust the operation of the boat 200. For example, the computer may adjust the trim of the propulsion system 204. As another example, the computer may adjust (e.g., increase or decrease) the thrust of the propulsion system 204. The computer may output data indicative of the pitch of the boat 200 to a display screen viewable to an operator of the boat 200.

A set of electrodes 20, 22, may similarly extend along one or both of the sides of the hull 202 from the top toward the bottom to determine the heel angle or roll of the boat 200. As the boat 200 tilts from side to side, the length of the electrodes 20, 22 submersed in the water may increase and/or decrease. A computer of the boat 200 may receive the data from the fluid level sensing apparatus 10 indicating the side portion of the hull 202 submersed in water. The computer may determine the roll of the boat 200 and may automatically adjust the operation of the boat 200. For example, the computer may move a sail of the boat 200 and/or turn the boat 200 (e.g., with a rudder of the boat 200). The computer may output data indicative of the roll of the boat 200 to a display screen viewable to an operator of the boat 200.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of”′ as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1-22. (canceled)

23. A watercraft comprising:
a hull feature at least partially submersible in a body of water;
at least one source electrode disposed on the hull feature;
at least one receiver electrode disposed on the hull feature and spaced apart from the at least one source electrode;
a sensing circuit configured to output a repeating pulse signal to the at least one source electrode and to receive a return signal from the at least one receiver electrode when the at least one source electrode and the at least one receiver electrode are at least partially submersed in the body of water, the sensing circuit configured to output a depth signal corresponding to an extent to which the hull feature is submersed in the body of water based on the return signal.

24. The watercraft of claim 23 wherein the sensing circuit further comprises a DC barrier comprising:
a source capacitor disposed inline between the sensing circuit and the at least one source electrode; and
a receiver capacitor disposed inline between the sensing circuit and the at least one receiver electrode.

25. The watercraft of claim 23 wherein the sensing circuit further comprises:
a first isolating transformer disposed inline between the sensing circuit and the at least one source electrode; and
a second isolating transformer disposed inline between the sensing circuit and the at least one receiver electrode.

26. The watercraft of claim 23 wherein the repeating pulse signal is an alternating current signal.

27. The watercraft of claim 23 wherein a change in resistance between the at least one source electrode and the at least one receiver electrode, indicated based on the return signal, causes the sensing circuit to change the depth signal.

28. The watercraft of claim 23:
wherein the at least one source electrode includes a plurality of source electrodes each mounted along the hull feature at different heights;
wherein the at least one receiver electrode includes a plurality of receiver electrodes each mounted along the hull feature at different heights; and
wherein the sensing circuit is configured to output the repeating pulse signal to the plurality of source electrodes and receive the return signal from receiver electrodes of the plurality of receiver electrodes that are submersed in the body of water.

29. The watercraft of claim 28 wherein each source electrode of the plurality of source electrodes is exposed through an opening in the hull feature.

30. The watercraft of claim 23 wherein the at least one source electrode and the at least one receiver electrode are embedded in the hull feature.

31. The watercraft of claim 23 wherein the hull feature includes a first slot and a second slot extending along at least a portion thereof, the at least one source electrode disposed in the first slot and the at least one receiver electrode disposed in the second slot.

32. The watercraft of claim 23:
wherein the hull feature is formed of carbon fiber;
wherein the at least one source electrode and the at least one receiver electrode are inlaid in the carbon fiber hull feature.

33. The watercraft of claim 23 wherein the at least one source electrode and the at least one receiver electrode are electroplated on the hull feature.

34. The watercraft of claim 23 wherein the at least one source electrode and the at least one receiver electrode are secured to an outer surface of the hull feature by one or more of a fastener and/or an adhesive.

35. The watercraft of claim 23 wherein the at least one source electrode forms a first portion of the hull feature and the at least one receiver electrode forms a second portion of the hull feature, the hull feature further including an insulator between the first portion and second portion.

36. The watercraft of claim 23 wherein the hull feature includes a strut extending to a hydrofoil wing, the at least one source electrode and at least one receiver electrode disposed along the strut.

37. The watercraft of claim 23 further comprising:
a board having an upper surface and a lower surface, the hull feature including a strut extending from the lower surface of the board; and
a propulsion system mounted to the strut.

38. The watercraft of claim 37 wherein the at least one source electrode and the at least one receiver electrode extend along an upper portion of the strut.

39. A method of operating a watercraft disposed in a body of water, the method comprising:
outputting a repeating pulse signal from a fluid sensing apparatus to at least one source electrode extending along a hull feature of the watercraft;
receiving a return signal at the fluid sensing apparatus from at least one receiver electrode extending along the hull feature of the watercraft and spaced apart from the at least one source electrode, the return signal conducted through the body of water from the at least one source electrode to the at least one receiver electrode;
outputting a depth signal from a sensing circuit of the fluid sensing apparatus, the depth signal corresponding to an extent to which the hull feature is submersed in the body of water based at least in part upon the return signal; and
automatically adjusting operation of the watercraft based upon the depth signal.

40. The method of claim 39:
wherein outputting the repeating pulse signal includes outputting the repeating pulse signal through a source capacitor to at least one source electrode;
wherein receiving the return signal includes receiving the return signal through a receiver capacitor from the at least one receiver electrode.

41. The method of claim 39 wherein adjusting operation of the watercraft includes adjusting a thrust of a propulsion system of the watercraft.

42. The method of claim 39 wherein adjusting operation of the watercraft includes adjusting a position of a movable control surface of the watercraft.

43. The method of claim 39 wherein adjusting operation of the watercraft includes adjusting a trim of a propulsion system of the watercraft.

44. The method of claim 39:
wherein the at least one receiver electrode includes a plurality of electrodes disposed at varying heights along the hull feature;
wherein the at least one source electrode includes a plurality of electrodes disposed at varying heights along the hull feature.

45. The method of claim 39 wherein the hull feature includes a strut and a hydrofoil connected to the strut, wherein the at least one source electrode and the at least one receiver electrode are disposed along at least a portion of the strut.

46. The method of claim 39 wherein outputting the depth signal is based at least in part on an amplitude of the return signal.

47. The method of claim 39 further comprising comparing the depth signal to a data structure correlating the depth signal to an extent to which the hull feature is submersed in the body of water.

48. The method of claim 39 further comprising calculating an extent to which the hull feature is submersed in the body of water based on the depth signal.

49. The method of claim 39 further comprising:
submersing the hull feature to a predetermined depth in the body of water; and
calibrating the fluid sensing apparatus when the hull feature is submersed to the predetermined depth in the body of water.

50. The method of claim 49 wherein the calibrating further comprises adjusting a resistance of a potentiometer such that the depth signal corresponds to an expected depth signal corresponding to the predetermined depth.

51. The method of claim 49 wherein calibrating the fluid sensing apparatus includes adjusting a gain of an operational amplifier circuit of the sensing circuit such that the depth signal corresponds to an expected depth signal corresponding to the predetermined depth.

52. The method of claim 49 wherein calibrating the fluid sensing apparatus includes adjusting a power of the repeating pulse signal output from the fluid sensing apparatus.
